(19) United States
(12) Patent Application Publication
(10) Pub. No.: US 2013/0254702 A1
(43) Pub. Date: Sep. 26, 2013

(54) Method and Device for Displaying Window of Security Class Software

(71) Applicant: TENCENT TECHNOLOGY (SHENZHEN) COMPANY LIMITED, Shenzhen (CN)

(72) Inventors: Weibin Pan, Shenzhen (CN); Jun Wang, Shenzhen (CN); Sha Liu, Shenzhen (CN); Liang Peng, Shenzhen (CN); Shuoting Chen, Shenzhen (CN); Xin Liu, Shenzhen (CN); Guoping Liu, Shenzhen (CN); Lingling Zou, Shenzhen (CN); Mu Tang, Shenzhen (CN); Yongyu Dai, Shenzhen (CN); Jian Du, Shenzhen (CN)

(73) Assignee: TENCENT TECHNOLOGY (SHENZHEN) COMPANY LIMITED, Shenzhen (CN)

(21) Appl. No.: 13/900,638

(22) Filed: May 23, 2013

Related U.S. Application Data
(63) Continuation of application No. PCT/CN2011/083404, filed on Dec. 2, 2011.

(30) Foreign Application Priority Data
Jan. 11, 2011 (CN) 201110004615.8

(51) Int. Cl. G06F 3/0481

(52) U.S. Cl. CPC G06F 3/0481
USPC 715/781

(57) ABSTRACT

A method and device for displaying a window of security class software are disclosed. The method includes processing a window based on a selected window style according to a detection result of a security status of a processing equipment detected by the security class software, and displaying the window corresponding to the detection result. Based on characteristics of the security class software, a solution that can display different windows under one window style according to the detection result of the processing equipment is provided, so that a user can intuitively know the current security status of the processing equipment through an intelligently displayed window. Using skin change technology of the security class software, a user can be informed intuitively and vividly that whether the processing equipment used by the user is safe or not. When the processing equipment is unsafe, the user is prompted timely to eliminate potential safety hazard or search and kill viruses, thereby realizing a friend human-computer interaction.

### CROSS REFERENCE TO RELATED APPLICATIONS

This is a continuation application of International Patent Application No.: PCT/CN2011/083404, filed on Dec. 2, 2011, which claims priority to Chinese Patent Application No.: 201110004615.8, filed on Jan. 11, 2011, the disclosure of which is incorporated by reference herein in its entirety.

### TECHNICAL FIELD

The disclosure relates to the computer technology, and more particularly, to a method and a device for displaying a window of security class software.

### BACKGROUND

The skin change technology is a product of diversification of software users. A user will feel cheesed when facing one style of display window for a long time, window styles of software is thus desired to be changed. Therefore, the technology of skin change appears accordingly. A software developer provides several sets of designated window styles to the user for selection. As shown in FIG. 1, when a main program is entered for the first time, the displayed window is of a default window style, the user can then perform selection among the several sets of the designated window styles, the selected window style is displayed after the selection of the user is received to complete the skin change. When the main program is entered next time, the displayed window is of the window style after the skin change, i.e., the window style selected by the user.

Built-in window styles of software are very few and relatively rigid, the user will still produce visual fatigue and dislike after using the built-in window styles for a long time. In addition, contemporary young people pursuit personalized usage mode. Therefore, many software developers provide personalized skin change technologies, which are capable of satisfying personalized requirements of people by enabling a user to set the window style according to idea of the user, thereby adapting to requirements of different groups of people. In addition, the software developers generally may also provide shared service, so that the user can share the set window style with others.

As shown in FIG. 2, when a main program is entered for the first time, the displayed window is of a default window style. A user can set a personalized window style according to his favoured colour, pattern, or decorative pattern. The user-defined window style may be added to the window style, and then the user can select one from the built-in window style of the software and the user-defined window style. The selected window style is displayed after the selection of the user is received to complete skin change. When the main program is entered next time, the displaying window is of the window style after the skin change, i.e., the window style selected by the user.

At present, various security class software for computer security appear, the skin change technology of which is the same as that of other general software, both are only simple change of the window style and cannot perform intelligent skin change in combination with the characteristics of the security class software.

### SUMMARY

In view of the above, the main purpose of the disclosure is to provide a method and a device for displaying a window of security class software, which is able to intelligently perform skin change in combination with the characteristics of the security class software.

In order to achieve above purpose, the technical solutions of the disclosure are provided as follows.

A method for displaying a window of security class software is provided, which includes: processing a window based on a selected window style according to a detection result of a security status of a processing equipment detected by the security class software, and displaying the window corresponding to the detection result.

The processing the window based on the selected window style according to the detection result of the security status of the processing equipment detected by the security class software may include: detecting, by the security class software, the security status of the processing equipment, and processing the window based on the selected window style according to the detection result.

The processing the window based on the selected window style according to the detection result may include:

when the detection result is that the processing equipment is running safely, processing, based on the selected window style, the window to be a window displayed when a safe operation is detected;

when the detection result is that a potential safety hazard exists in the processing equipment, processing, based on the selected window style, the window to be a window displayed when a potential safety hazard exists; and

when the detection result is that the processing equipment is infected by a virus, processing, based on the selected window style, the window to be a window displayed when there is a virus infection.

The processing the window based on the selected window style according to the detection result may include: processing, by the security class software, the window in accordance with a set rule based on the selected window style according to the detection result.

The method may further include the step, performed before the window is processed based on the selected window style according to the detection result of the security status of the processing equipment detected by the security class software, of: presetting a window corresponding to the detection result for each available window style. The processing the window based on the selected window style according to the detection result may include: invoking the corresponding window based on the selected window style according to the detection result.

The method may further include the step, performed before the window is processed based on the selected window style according to the detection result of the security status of the processing equipment detected by the security class software, of: selecting the window style of the security class software according to received user input information.

The selecting the window style of the security class software may include: selecting a window style from a built-in window style of the security class software and a user-defined window style.

A device for displaying a window of security class software is provided, which includes:

a detection unit located in the security class software and configured to detect a security status of a processing equipment;

a processing unit configured to process the window based on a selected window style according to the detection result obtained by the detection unit; and

a displaying unit configured to display the window corresponding to the detection result.

The device may further include a selecting unit configured to select the window style of the security class software according to received user input information.

The device may further include a customizing unit configured to generate a user-defined window style according to the received user input information.

Based on characteristics of the security class software, the disclosure provides a solution which can display different windows under one window style according to the detection result of the processing equipment, so that a user can intuitively know the current security status of the processing equipment through the intelligently displayed window. Using skin change technology of the security class software, a user can be informed intuitively and vividly that whether the processing equipment used by the user is safe or not. When the processing equipment is unsafe, the user is prompted timely to eliminate potential safety hazard or search and kill viruses, thereby realizing a friend human-computer interaction.

In addition, the solution of the disclosure is to intelligently display different windows according to the different detection results of the security status of the processing equipment. That is, the user is informed of the current security status of the processing equipment through displaying, which not only is adapted to general users, but also is preferably adapted to users who are amblyopic, or are of poor reading ability, or are after fashion and individuation.

### BRIEF DESCRIPTION OF THE DRAWINGS

FIG. 1 shows a schematic diagram of implementation of a skin change technology in the prior art;

FIG. 2 shows a schematic diagram of implementation of another skin change technology in the prior art;

FIG. 3 shows a flowchart of implementing displaying of a window of security class software according to the disclosure;

FIG. 4 shows a schematic diagram of processing a window according to the disclosure;

FIG. 5 shows a schematic structure diagram of the device for displaying a window of security class software according to the disclosure;

FIG. 6 shows a schematic diagram of displaying a window when a safe operation is detected according to the disclosure;

FIG. 7 shows a schematic diagram of displaying a window when potential safety hazard exists according to the disclosure; and

FIG. 8 shows a schematic diagram of displaying a window when there is a virus infection according to the disclosure.

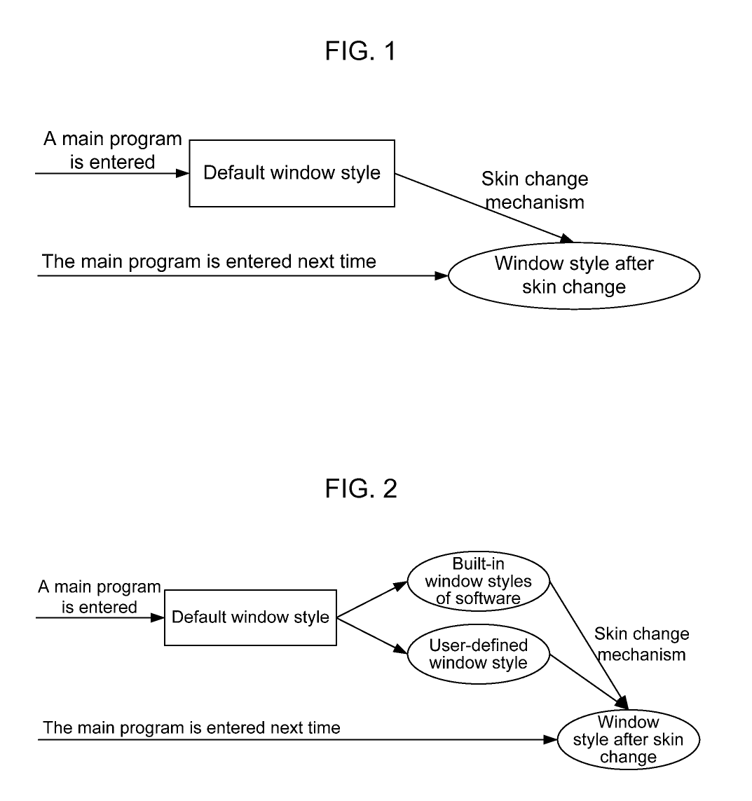

### DETAILED DESCRIPTION

In the disclosure, a window is processed based on a selected window style according to a detection result of a security status of a processing equipment detected by the security class software, and the window corresponding to the detection result is displayed. Specifically, the processing equipment may be a device having processing capacity, such as a computer, a mobile terminal and a Personal Digital Assistant (PDA). The detection result includes information indicating the security status of the processing equipment, such as safe operation, existence of potential safety hazard and virus infection.

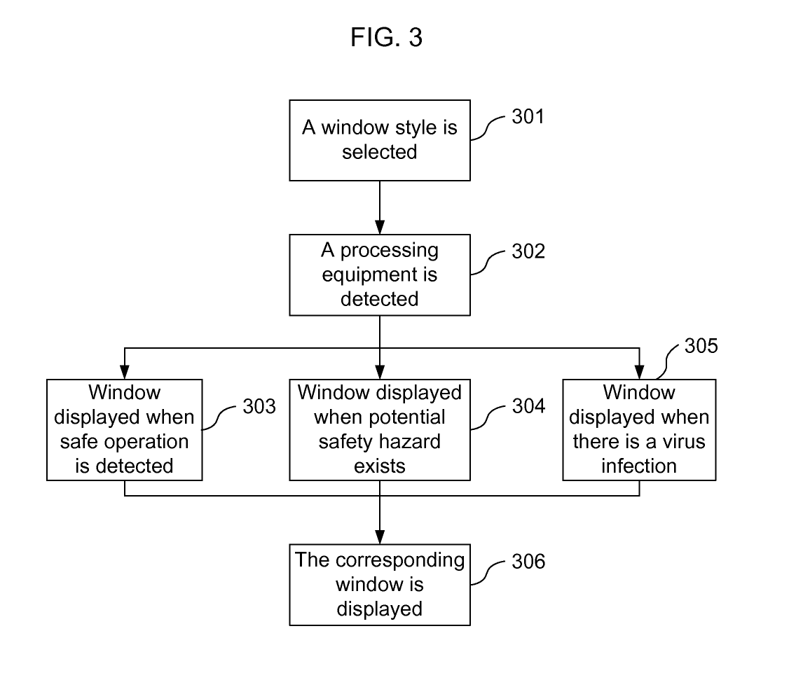

FIG. 3 shows a flowchart of implementing displaying of window of security class software according to the disclosure. As shown in FIG. 3, the processing processes of implementing displaying of window of security class software include following steps.

Step 301: A window style of security class software is selected.

A user triggers a skin change mechanism and selects the window style of the security class software. The user can select one window style from a built-in window style of the security class software and a user-defined window style. The security class software selects the window style according to user input information.

Step 302: After receiving the user input information of selecting the window style, the security class software detects the security status of the processing equipment, and processes the window based on the selected window style according to the detection result by executing Step 303, or Step 304, or Step 305.

After receiving the user input information of selecting the window style, the security class software triggers detection of the security status of the processing equipment. The detection of the security status of the processing equipment performed by the security class software is identical with a function of a security class software in the prior art, description of which is not detailed herein.

Step 303: When the detection result is that the processing equipment is running safely, the window is processed to be a window displayed when a safe operation is detected based on the selected window style.

After the security class software detects the security status of the processing equipment, when the obtained detection result is that the processing equipment is running safely, the security class software processes the window to be the window displayed when a safe operation is detected based on the selected window style.

Step 304: When the detection result is that a potential safety hazard exists in the processing equipment, the window is processed to be a window displayed when a potential safety hazard exists based on the selected window style.

After the security class software detects the security status of the processing equipment, when the obtained detection result is that the potential safety hazard exists, the security class software processes the window to be a window displayed when the potential safety hazard exists based on the selected window style. The safety hazard may be a software patch or bug.

Step 305: When the detection result is that the processing equipment is infected by a virus, the window is processed to be a window displayed when there is a virus infection based on the selected window style.

After the security class software detects the security status of the processing equipment, when the obtained detection result is that the processing equipment is infected by a virus, the security class software processes the window to be the window displayed when there is a virus infection based on the selected window style.

Step 306: The corresponding window is displayed.

The security class software displays the corresponding window, which is the window corresponding to the detection result.

It can be seen from the above description that the security class software intelligently displays the corresponding window to the user according to the detection result, and intuitively and vividly informs the user of the current security status of the processing equipment using characteristics of the security class software, so that the user is prompted timely to eliminate potential safety hazard or search and kill viruses when the processing equipment is unsafe, thereby leading to a friend human-computer interaction.

That the window is processed based on the selected window style according to the detection result may include that: the security class software processes the window in accordance with a set rule based on the selected window style according to the detection result. For example, the set rule is that: when the detection result is that the processing equipment is running safely, elements such as pattern of the window, control style, font colour, font size and the like are not processed; when the detection result is that potential safety hazard exists in the processing equipment, one or more of elements such as the pattern of the window, the control style, the font colour, the font size and the like is performed mild rendering processing, for example, appropriately zooming in a part of pattern of the window, and/or appropriately deepening the font colour, and/or appropriately zooming in the font size, or the like; and when the detection result is that the processing equipment is infected by a virus, one or more of elements such as the pattern of the window, the control style, the font colour, the font size and the like is performed severe rendering processing, for example, highlighting a part of pattern of the window, and/or deepening the font colour, and/or very obviously zooming in the font size, or the like. In this way, after the detection result is obtained, the window is processed correspondingly in accordance with the set rule. When one or more of elements such as the pattern of the window, the control style, the font colour, the font size and the like need to be performed mild rendering processing or severe rendering processing, a window redrawing mechanism is triggered to redraw one or more of the elements such as the pattern of the window, the control style, the font colour, the font size and the like.

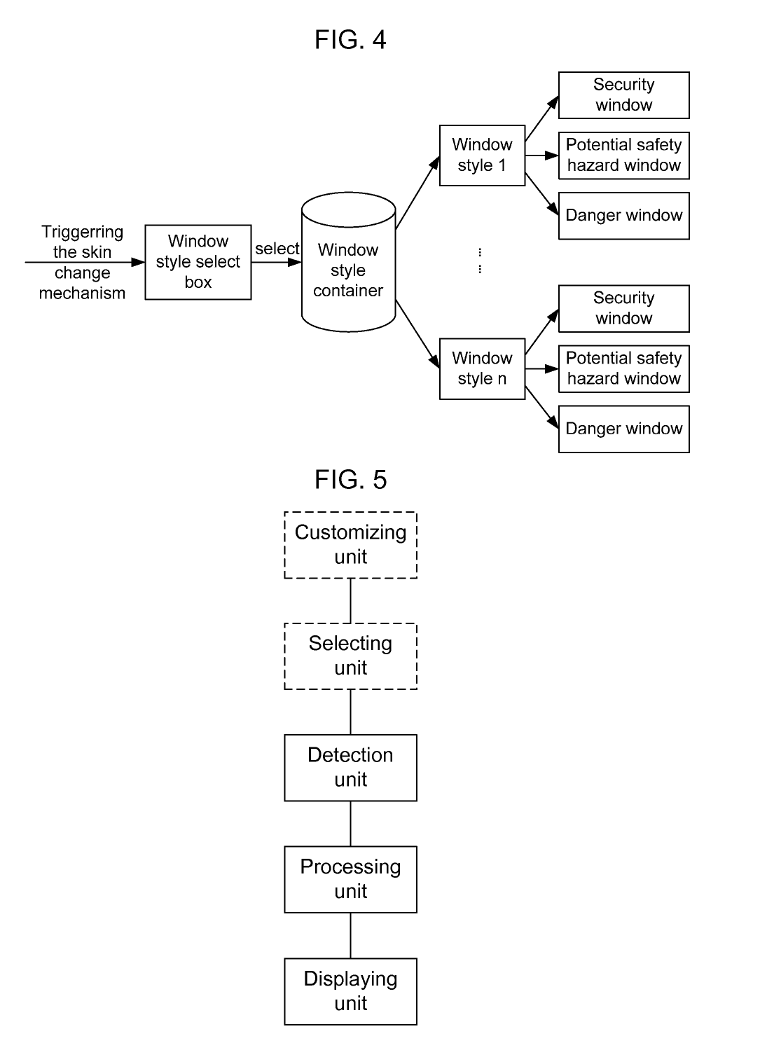

That the window is processed based on the selected window style according to the detection result may include that: the window corresponding to the detection result is preset for each available window style, that is, three different security levels of the window are set for each set of skin changeable window style. For example, after the security class software detects the security status of the processing equipment, the detection results obtained may be safe operation, the existence of potential safety hazard, or the virus infection. For each available window style, a security window, a potential safety hazard window and a virus window are set to respectively correspond to each detection result (the safe operation, the existence of potential safety hazard, or the virus infection). After the detection result is obtained, the corresponding window is invoked based on the selected window style according to the detection result, that is, when the detection result is that the processing equipment is running safely, the security window in the selected window style is invoked; when the detection result is that potential safety hazard exists in the processing equipment, the potential safety hazard window in the selected window style is invoked; and when the detection result is that the processing equipment is infected by a virus, the virus window in the selected window style is invoked. As shown in FIG. 4, all window styles can be placed in a window style container, and a set of mapping mechanism is established for each window style, that is, each window style is provided with the window corresponding to the detection result. For example, a window style 1 includes the security window, the potential safety hazard window, and the danger window, so that processing of skin change can be performed dynamically based on the detection result in subsequent processing, that is, the window corresponding to the corresponding security level is displayed dynamically according to the detection result of the security status of the processing equipment detected by the security class software. Each window is composed of a serial of elements such as the pattern of the window, the control style, the font colour, the font size and the like, and these elements can be set according to a window configuration style by the user manually or by the security class software automatically.

FIG. 5 shows a schematic structure diagram of the device for displaying a window of security class software according to the disclosure. As shown in FIG. 5, the device includes a detection unit, a processing unit and a displaying unit. The detection unit is located in the security class software and is configured to detect a security status of a processing equipment. The processing unit is configured to process the window based on a selected window style according to the detection result obtained by the detection unit. The displaying unit is configured to display the window corresponding to the detection result. The processing unit can be located internal or external the security class software.

The device further includes a selecting unit configured to select the window style of the security class software according to received user input information.

The selected window style can be a built-in window style of the security class software or a user-defined window style. When the selected window style is the user-defined window style, the device further includes a customizing unit configured to generate a user-defined window style according to the received user input information. The received user input information may be colour, pattern or decorative pattern or the like selected by the user.

Specific realization of each unit described above is identical with the related description about the foregoing method, and is therefore not described in detail herein.

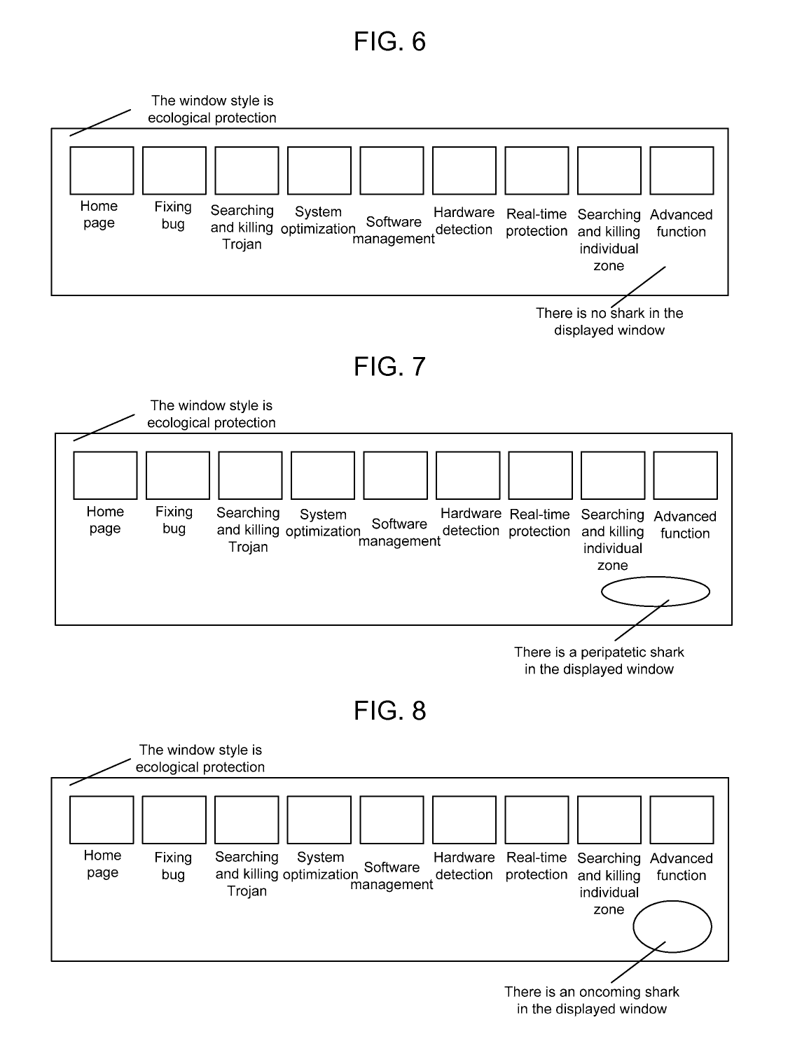

Based on the detection result of the security status of the processing equipment selected by the security class software, the solution of the disclosure displays different windows to the user, in order to intuitively prompt the user the current security status of the processing equipment. FIGS. 6 to 8 are the schematic diagrams of windows of the security class software obtained according to the above solution. It can be seen from FIGS. 6 to 8 that, according to the solution of the disclosure and based on the selected window style (e.g. ecological protection), if the detection result is that the processing equipment is running safely, then there is no shark in the displayed window, which reflects a harmonious atmosphere to inform the user that the current security status of the processing equipment is fine; if the detection result is that a potential safety hazard exists in the processing equipment, then there is a peripatetic shark in the displayed window, which reflects a crisis atmosphere to prompt the user timely that the processing equipment will be under threat at any time and the potential safety hazard shall be eliminated; and if the detection result is that the processing equipment is infected by a virus, then there is an oncoming shark in the displayed window, which reflects an attacked atmosphere to prompt the user timely that the processing equipment is infected by a virus and may therefore be unable to operate normally, and the virus shall be searched and killed. The corresponding window is intelligently displayed to the user according to the detection result, and intuitively and vividly informs the user of the current security status of the processing equipment using the characteristics of the security class software, so that the user is prompted timely to eliminate potential safety hazard or search and kill viruses when the processing equipment is unsafe, thereby leading to a friend human-computer interaction.

In addition, after the user eliminates potential safety hazard or searches and kills viruses in time according to the displayed window, the detection of the security status of the processing equipment may be performed again. And based on the detection result obtained, the above described processes are repeated. The specific processing is completely same and is therefore not described repeatedly herein.

The above are only the preferred embodiments of the disclosure and are not used for limiting the scope of protection of the disclosure. Any modifications, equivalent replacements, improvements or the like made within the concept and principle of the disclosure shall fall within the scope of protection of the disclosure.

1. A method for displaying a window of security class software, comprising:
processing a window based on a selected window style according to a detection result of a security status of a processing equipment detected by the security class software, and displaying the window corresponding to the detection result.

2. The method according to claim 1, wherein the processing the window based on the selected window style according to the detection result of the security status of the processing equipment detected by the security class software comprises:
detecting, by the security class software, the security status of the processing equipment, and processing the window based on the selected window style according to the detection result.

3. The method according to claim 2, wherein the processing the window based on the selected window style according to the detection result comprises:
when the detection result is that the processing equipment is running safely, processing, based on the selected window style, the window to be a window displayed when a safe operation is detected.

4. The method according to claim 2, wherein the processing the window based on the selected window style according to the detection result comprises:
processing, by the security class software, the window in accordance with a set rule based on the selected window style according to the detection result.

5. The method according to claim 2, further comprising the step, performed before the processing the window based on the selected window style according to the detection result of the security status of the processing equipment detected by the security class software, of presetting a window corresponding to the detection result for each available window style;
wherein the processing the window based on the selected window style according to the detection result comprises: invoking a corresponding window based on the selected window style according to the detection result.

6. The method according to claim 1, further comprising the step, performed before the processing the window based on the selected window style according to the detection result of the security status of the processing equipment detected by the security class software, of selecting the window style of the security class software according to received user input information.

7. The method according to claim 6, wherein the selecting the window style of the security class software comprises:
selecting a window style from a built-in window style of the security class software and a user-defined window style.

8. A device for displaying a window of security class software, comprising:
a detection unit located in the security class software and configured to detect a security status of a processing equipment;
a processing unit configured to process the window based on a selected window style according to the detection result obtained by the detection unit; and
a displaying unit configured to display the window corresponding to the detection result.

9. The device according to claim 8, further comprising:
a selecting unit configured to select the window style of the security class software according to received user input information.

10. The device according to claim 8, further comprising:
a customizing unit configured to generate a user-defined window style according to received user input information.

11. The method according to claim 2, further comprising the step, performed before the processing the window based on the selected window style according to the detection result of the security status of the processing equipment detected by the security class software, of selecting the window style of the security class software according to received user input information.

12. The method according to claim 11, wherein the selecting the window style of the security class software comprises:
selecting a window style from a built-in window style of the security class software and a user-defined window style.

13. The method according to claim 2, wherein the processing the window based on the selected window style according to the detection result comprises:
when the detection result is that a potential safety hazard exists in the processing equipment, processing, based on the selected window style, the window to be a window displayed when a potential safety hazard exists.

14. The method according to claim 2, wherein the processing the window based on the selected window style according to the detection result comprises:
when the detection result is that the processing equipment is infected by a virus, processing, based on the selected window style, the window to be a window displayed when there is a virus infection.

15. The device according to claim 9, further comprising:
a customizing unit configured to generate a user-defined window style according to received user input information.
